(19) United States
(12) Patent Application Publication
(10) Pub. No.: US 2007/0125661 A1
(43) Pub. Date: Jun. 7, 2007

(54) Controlling removal rate uniformity of an electropolishing process in integrated circuit fabrication

(75) Inventors: Hui Wang, Fremont, CA (US); Afnan Muhammed, Fremont, CA (US); Jian Wang, Fremont, CA (US); Felix Gutman, San Jose, CA (US); Frederick Ho, San Jose, CA (US); Himanshu J. Chocshi, Fremont, CA (US)

Correspondence Address: MORRISON & FOERSTER LLP, 425 MARKET STREET, SAN FRANCISCO, CA, 94105-2482, US

(73) Assignee: ACM RESEARCH INC., FREMONT CALIFORNIA, CA (US)

(21) Appl. No.: 10/590,460

(22) PCT Filed: Feb. 23, 2005
(86) PCT No.: PCT/US05/06142

§ 371 Date: Aug. 22, 2006

Related U.S. Application Data
(60) Provisional application No. 60/546,848, filed on Feb. 23, 2004.
(60) Provisional application No. 60/551,632, filed on Mar. 7, 2004.

(51) Int. Cl. B23H 3/00

(52) U.S. Cl. 205/651

(57) ABSTRACT

A metal layer formed on a wafer, the wafer having a center portion and an edge portion, is electropolished by aligning a nozzle and the wafer to position the nozzle adjacent to the center portion of the wafer. The wafer is rotated. As the wafer is rotated, a stream of electrolyte is applied from the nozzle onto a portion of the metal layer adjacent to the center portion of the wafer to begin to electropolish the portion of the metal layer with a triangular polishing profile to initially expose an underlying layer underneath the metal layer at a point.

### CROSS-REFERENCE TO RELATED APPLICATIONS

The present application claims the benefit of U.S. Provisional Application No. 60/546,848, filed Feb. 23, 2004, which is incorporated herein by reference in its entirety, and U.S. Provisional Application No. 551,632, filed Mar. 7, 2004, which is incorporated herein by reference in its entirety.

### BACKGROUND

1. Field

The present application generally relates to an electropolishing process used in integrated circuit (IC) fabrication, and, in particular, to controlling removal rate uniformity during an electropolishing process of a metal layer formed on a wafer used in IC fabrication.

2. Related Art

IC devices are manufactured or fabricated on wafers using a number of different processing steps to create transistor and interconnection elements. To electrically connect transistor terminals associated with the wafer, conductive (e.g., metal) trenches, vias, and the like are formed in dielectric materials as part of IC devices. The trenches and vias couple electrical signals and power between transistors, internal circuits of the IC devices, and circuits external to the IC devices.

In forming the interconnection elements, the wafer may undergo, for example, masking, etching, and deposition processes to form the desired electronic circuitry of the IC devices. In particular, multiple masking and etching steps can be performed to form a pattern of recessed areas in a dielectric layer on a wafer that serve as trenches and vias for the interconnections. A deposition process may then be performed to deposit a metal layer over the wafer to deposit metal both in the trenches and vias and also on the non-recessed areas of the wafer. To isolate the interconnections, such as patterned trenches and vias, the metal deposited on the non-recessed areas of the wafer is removed.

The metal layer deposited on the non-recessed areas of the dielectric layer can be removed using an electropolishing process. In particular, a nozzle can be used to apply an electrolyte solution to electropolish the metal layer. As the feature size of the IC devices continues to decrease, however, the removal rate uniformity of the electropolishing process needs to be enhanced.

### SUMMARY

In one exemplary embodiment, a metal layer formed on a wafer, the wafer having a center portion and an edge portion, is electropolished by aligning a nozzle and the wafer to position the nozzle adjacent to the center portion of the wafer. The wafer is rotated. As the wafer is rotated, a stream of electrolyte is applied from the nozzle onto a portion of the metal layer adjacent to the center portion of the wafer to begin to electropolish the portion of the metal layer with a triangular polishing profile to initially expose an underlying layer underneath the metal layer at a point.

### BRIEF DESCRIPTION OF THE DRAWINGS

FIGS. 1A-1F are block diagrams of exemplary electropolishing tools;

FIG. 2 depicts an exemplary nozzle adjacent to a wafer during an electropolishing process;

FIGS. 3A-3D depict exemplary thicknesses of a metal layer on a wafer during an electropolishing process;

FIGS. 4A-4D depict exemplary polishing profiles associated with an exemplary electropolishing process;

FIGS. 5A-5D depict exemplary polishing profiles associated with another exemplary electropolishing process;

FIG. 6 depicts exemplary polishing profiles associated with different polishing currents;

FIG. 7 depicts exemplary polishing profiles associated with different sized nozzles;

FIG. 8 depicts an exemplary polishing profile associated with another exemplary electropolishing process;

FIG. 9 depicts an exemplary polishing profile associated with another exemplary polishing process;

FIG. 10 depicts the thickness profile of a metal layer on a wafer;

FIG. 11 depicts sets of averaged thicknesses of a metal layer on a wafer;

FIG. 12 depicts an exemplary lateral relative speed compensation curve;

FIG. 13 depicts a curve of averaged thicknesses and a curve of thicknesses across a wafer;

FIG. 14 depicts a triangular polishing profile;

FIG. 15 depicts a polishing profile resulting from adjusting the lateral relative speed of the wafer;

FIGS. 16A and 16B depict contact areas associated with a stream of electrolyte applied to a metal layer on a wafer;

FIG. 17 depicts a relationship between removal rate and polishing current density;

FIG. 18 depicts a relationship between contact area and removal rate;

FIG. 19 depicts a relationship between physical viscosity and contact area;

FIG. 20 depicts a relationship between physical viscosity and removal rate;

FIG. 21 depicts a relationship between temperature and physical viscosity;

FIG. 22 depicts a relationship between temperature and temperature compensated viscosity;

FIG. 23 depicts a relationship between water content in electrolyte to temperature compensated viscosity;

FIG. 24 depicts a relationship between temperature and polishing efficiency;

FIG. 25 depicts a top of of an exemplary system to control viscosity and water content in electrolyte;

FIG. 26 depicts an exemplary electrolyte supply system;

FIGS. 27-29 depict various portions of the system depicted in FIG. 26;

FIG. 30 depicts a simplified block diagram of the system depicted in FIG. 26; and

FIG. 31 depicts a top view of an exemplary electrolyte reservoir.

### DETAILED DESCRIPTION

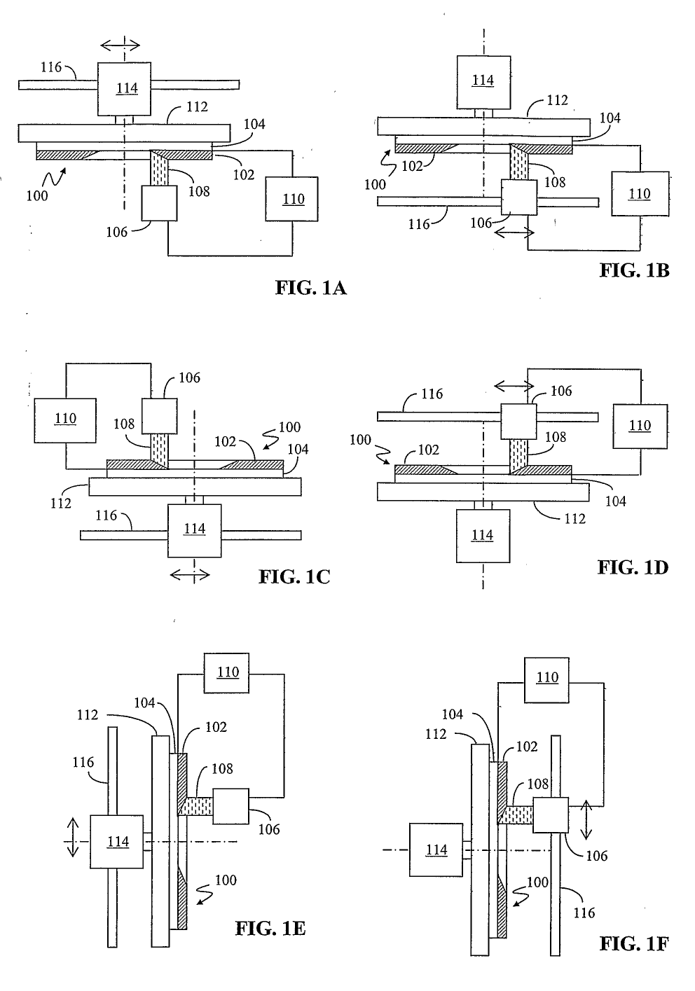

With reference to FIG. 1A, as part of an IC fabrication process, an exemplary electropolishing tool is configured to electropolish a metal layer 102 formed on a wafer 100. Metal layer 102 can include copper, which is increasingly being used to replace aluminum. It should be recognized, however, that metal layer 102 can include any electrically conductive material. Although metal layer 102 is depicted as formed directly on substrate 104, it should be recognized that metal layer 102 can be formed on an underlying layer, such as a barrier layer, which can reduce the leeching of metal from metal layer 102. Additionally, it should be recognized that the term “wafer” can be used to refer to substrate 104 on which subsequent layers are formed, or to refer collectively to substrate 104 and the subsequent layers formed on substrate 104.

In one exemplary embodiment, the electropolishing tool includes a nozzle 106 configured to apply a stream of electrolyte 108 to metal layer 102 at different radial locations on wafer 100. A power supply 110 is connected to nozzle 106 to apply a negative electropolishing charge to stream of electrolyte 108. Power supply 110 is also connected to wafer 100 to apply a positive electropolishing charge to wafer 100. Thus, during the electropolishing process, nozzle 106 acts as a cathode, and wafer 100 acts as an anode. When stream of electrolyte 108 is applied to metal layer 102, the difference in potential between electrolyte 108 and metal layer 102 results in the electropolishing of metal layer 102 from wafer 100. Although power supply 110 is depicted as being directly connected to wafer 100, it should be recognized that any number intervening connection can exist between power supply 110 and wafer 100. For example, power supply 110 can be connected to chuck 112, which is then connected to wafer 100, and, more particular to metal layer 102. For an additional description of electropolishing, see U.S. patent application Ser. No. 09/497,894, entitled METHOD AND APPARATUS FOR ELECTROPOLISHING METAL INTERCONNECTIONS ON SEMICONDUCTOR DEVICES, filed on Feb. 4, 2000, which is incorporated herein by reference in its entirety.

In the exemplary embodiment depicted in FIG. 1A, the electropolishing tool includes a chuck 112 that holds and positions wafer 100. The electropolishing tool also includes a motor 114 that rotates chuck 112, and thus wafer 100, during the electropolishing process. By rotating wafer 100, electrolyte 108 is applied in a spiral pattern on metal layer 102. In particular, in the present exemplary embodiment, chuck 112, and thus wafer 100, is translated along a guide rod 116 to translate wafer 100 in a lateral direction relative to nozzle 106 and stream of electrolyte 108. The relative motion between nozzle 106 and wafer 100 produced by rotating and translating wafer 100 results in electrolyte 108 being applied in a spiral pattern. It should be recognized, however that the relative motion between nozzle 106 and wafer 100 can achieved in various manners. For example, nozzle 106 and wafer 100 can be moved in a straight or curved trajectory in the lateral direction,

Although in the exemplary embodiment depicted in FIG. 1A wafer 100 is rotated and translated while nozzle 106 is kept stationary, it should be recognized that nozzle 106 and wafer 100 can be moved relative to each other in various manners using various mechanisms. For example, in the exemplary embodiment depicted in FIG. 1B, wafer 100 is only rotated, while nozzle 106 is translated. Although in the exemplary embodiment depicted in FIG. 1A nozzle 106 is disposed below wafer 100 to apply stream of electrolyte 108 vertically up to metal layer 102, it should be recognized that nozzle 106 and wafer 100 can be oriented in various manners. For example, in the exemplary embodiment depicted in FIG. 1C, nozzle 106 is disposed above wafer 100 to apply stream of electrolyte 108 vertically down to metal layer 102. In the exemplary embodiment depicted in FIG. 1C, chuck 112, and thus wafer 100, is rotated and translated, while nozzle 106 is kept stationary. In the exemplary embodiment depicted in FIG. 1D, nozzle 106 is translated, while chuck 112, and thus wafer 100, is rotated. In the exemplary embodiment depicted in FIG. 1E, nozzle 106 is disposed horizontally adjacent to wafer 100 to apply stream of electrolyte 108 horizontally to metal layer 102. In the exemplary embodiment depicted in FIG. 1E, chuck 112, and thus wafer 100, is rotated and translated, while nozzle 106 is kept stationary. In the exemplary embodiment depicted in FIG. 1F, nozzle 106 is translated, while chuck 112, and thus wafer 100, is rotated. It should be recognized that in the exemplary embodiments depicted in FIGS. 1A-1F, both nozzle 106 and chuck 112, and thus wafer 100, can be translated simultaneously.

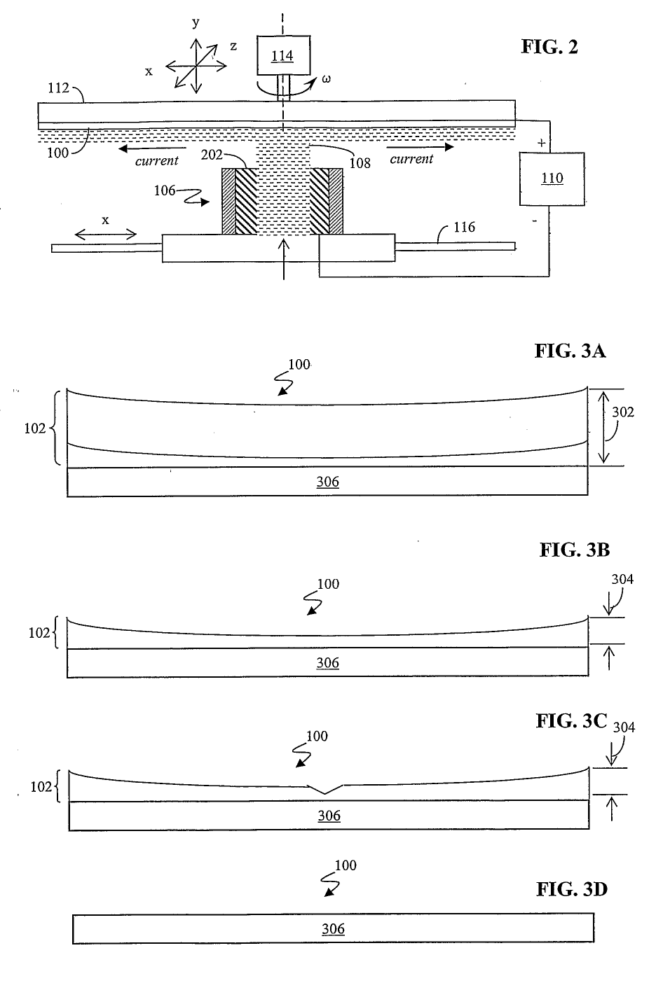

With reference to FIG. 2, in one exemplary embodiment, nozzle 106 includes an electrode 202 configured to apply a negative electropolishing charge to stream of electrolyte 108. In the present exemplary embodiment, the metal layer on wafer 100 makes contact with one or more electrode contacts located near the edge of wafer 100 (i.e., around the outer circumferential area of the surface on which the metal layer and IC structures are formed). In the present exemplary embodiment, before the electropolishing process begins, the metal layer is continuous from the center to near the edge, where the metal layer makes contact with the one or more electrode contacts. Thus, as depicted in FIG. 2, an electric current flows from stream of electrolyte 108 radially outward toward the edge of wafer 100. Although FIG. 2 depicts nozzle 106 on a guide rod 16, it should be recognized that nozzle 106 can be kept stationary while wafer 100 is moved in a lateral direction. Alternatively, both nozzle 106 and wafer 100 can be moved relative to one another in the lateral direction. See, U.S. Pat. No. 6,188,222, issued Jun. 19, 2001, which is incorporated herein by reference in its entirety.

With reference to FIGS. 3A-3D, an exemplary electropolishing process is depicted. In particular, FIG. 3A depicts an incoming wafer 100 with a metal layer 102 having an initial thickness 302, which typically ranges between about 0.5 μm and about 3 μm, before metal layer 102 is polished. As depicted in FIG. 3A, thickness 302 of metal layer 102 is typically greater toward the edge portion of wafer 100 than toward the center portion of wafer 100.

As depicted in FIG. 3B, in one exemplary embodiment, a first polishing stage is performed to reduce the initial thickness 302 (FIG. 3A) of metal layer 102 to an intermediate thickness 304, which typically ranges between 1000 Angstroms and 3000 Angstroms. It should be recognized that metal layer 102 can be polished from initial thickness 302 (FIG. 3A) to intermediate thickness 304 (FIG. 3B) using an electropolishing process or a non-electropolishing process, such as chemical-mechanical polishing (CMP).

In the present exemplary embodiment, after metal layer 102 has been polished to intermediate thickness 304, nozzle 106 (FIG. 2) and wafer 100 are aligned to position nozzle 106 (FIG. 2) adjacent to the center portion of wafer 100. As depicted in FIG. 3C, stream of electrolyte 108 (FIG. 2) is applied onto a portion of metal layer 102 adjacent to the center portion of wafer 100 to electropolish the portion of metal layer 102 to expose an underlying layer 306 underneath metal layer 102, such as a barrier layer. As will be described in greater detail below, in one exemplary embodiment, the portion of metal layer 102 adjacent to the center of wafer 100 is electropolished with a triangular polishing profile.

As depicted in FIG. 3D, stream of electrolyte 108 (FIG. 2) is applied from adjacent to the center portion of wafer 100 to the edge portion of wafer 100 to electropolish metal layer 102 to expose underlying layer 306. Thus, in the present exemplary embodiment, metal layer 102 (FIG. 3A) is removed in at least two stages (i.e., an initial polishing stage to reduce metal layer 102 from initial thickness 302 (FIG. 3A) to intermediate thickness 304 (FIG. 3B), and a subsequent electropolishing stage to remove metal layer 102 to expose underlying layer 306).

As noted above, with reference again to FIG. 2, stream of electrolyte 108 can be applied from the center portion of wafer 100 to the edge portion of wafer 100 by gradually moving nozzle 106, wafer 100, or both nozzle 106 and wafer 100. As also noted above, an electropolishing charge can be applied to stream of electrolyte 108 to electropolish metal layer 102.

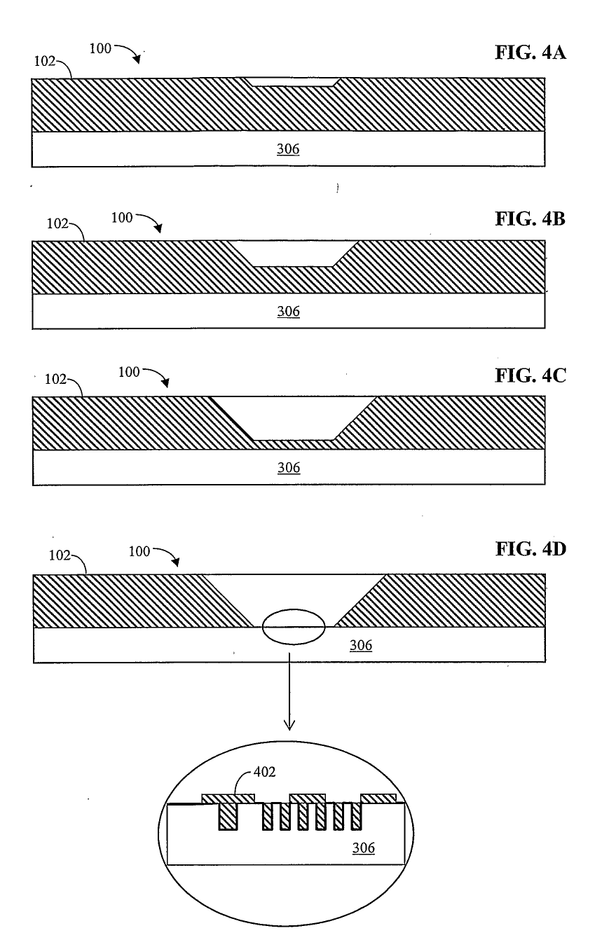

With reference to FIGS. 4A-4D, another exemplary electropolishing process is depicted, where metal layer 102 is removed in one stage. In particular, FIG. 4A depicts an incoming wafer 100 with metal layer 102 having an initial thickness before metal layer 102 is polished. With reference to FIG. 2, nozzle 106 and wafer 100 are aligned to position nozzle 106 adjacent to the center portion of wafer 100. Wafer 100 is rotated, while stream of electrolyte 108 is applied to the metal layer.

In the present exemplary embodiment, as depicted in FIG. 4A, the stream of electrolyte is applied from the nozzle onto the portion of metal layer 102 adjacent to the center portion of wafer 100 to begin to electropolish the portion of metal layer 102 with a trapezoidal polishing profile. In particular, before the thickness of metal layer 102 adjacent to the center portion of wafer 100 has been removed to expose underlying layer 306, the polishing profile has a trapezoidal profile, which, when viewed from a top view, would appear as a circular area (assuming a circular stream of electrolyte is used). Note that the trapezoidal polishing profile may result from the relative speed of wafer 100 to the nozzle being relatively large when the nozzle is adjacent to the center portion of wafer 100. See also, U.S. Pat. No. 6,395,152, issued May 28, 2002, which is incorporated herein by reference in its entirety.

As depicted in FIGS. 4B and 4C, as the stream of electrolyte electropolishes the portion of metal layer 102 adjacent to the center portion of wafer 100, the trapezoidal polishing profile. extends into metal layer 102. When the portion of metal layer 102 adjacent to the center portion of wafer 100 is thin (as depicted in FIG. 4C) or when underlying layer 306, such as the barrier layer, begins to be exposed (as depicted in FIG. 4D), the portion of metal layer 102 adjacent to the center portion of wafer 100 can begin to become discontinuous. When metal layer 102 becomes discontinuous, the polishing current path can seep through underlying layer 306.

For example, assume metal layer 102 is copper and underlying layer 306 is a barrier layer, which is typically Ta, TaN, Ti, TiN, W, WN. Because the resistivity of barrier layer 306 is typically ten to hundred times higher than that of copper, the polishing rate on a portion of metal layer 102 that is discontinuous with portions of the underlying barrier layer 306 exposed is much lower than if the portion was continuous without any of the underlying barrier layer 306 exposed.

As depicted in FIG. 4D, discontinuity in metal layer 102 can produce residuals 402, which remain on the underlying layer 306 after the electropolishing process. As also depicted in FIG. 4D, residual 402 can potentially create a short between features formed on wafer 100, such as between adjacent gates or lines.

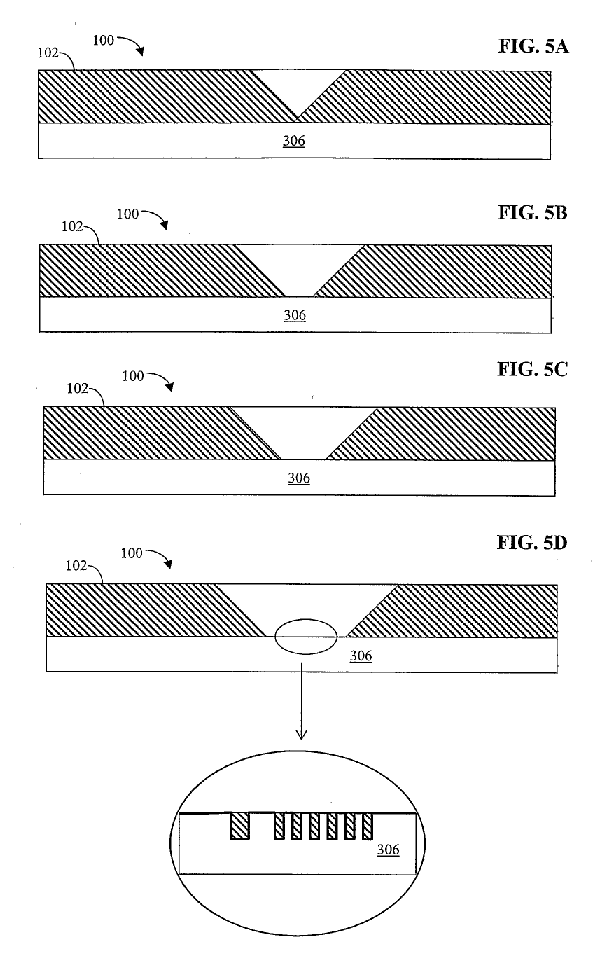

With reference to FIGS. 5A-5D, another exemplary electropolishing process is depicted, where metal layer 102 is removed in two stages. In particular, FIG. 5A depicts an incoming wafer 100 with metal layer 102 having an initial thickness 302 before metal layer 102 is polished. With reference to FIG. 2, nozzle 106 and wafer 100 are aligned to position nozzle 106 adjacent to the center portion of wafer 100. Wafer 100 is rotated, while stream of electrolyte 108 is applied to the metal layer.

In the present exemplary embodiment, as depicted in FIG. 5A, in a first stage, the stream of electrolyte is applied from the nozzle onto the portion of metal layer 102 adjacent to the center portion of wafer 100 to begin to electropolish the portion of metal layer 102 with a triangular polishing profile. In particular, before the thickness of metal layer 102 adjacent to the center portion of wafer 100 has been removed to expose underlying layer 306, the polishing profile has a triangular profile.

As depicted in FIG. 5A, as the stream of electrolyte electropolishes the portion of metal layer 102 adjacent to the center portion of wafer 100, the triangular polishing profile extends into metal layer 102 until underlying layer 306 underneath metal layer 102 is initially exposed at a point. It should be recognized that although the polishing profile has been described as being triangular and underlying layer 306 has been described as being initially exposed at a point, the apex of the polishing profile can be rounded.

After underlying layer 306 has been initially exposed at a point, in a second stage, the stream of electrolyte is applied from the nozzle onto additional portions of metal layer 102 extending from the center portion toward the edge portion of wafer 100. As will be described in more detail below, in the present exemplary embodiment, during this second stage, the shape of the polishing profile can be adjusted.

For example, as depicted in FIGS. 5B and 5C, as additional portions of metal layer 102 are removed, the polishing profile can be adjusted to have a flatter apex to be more trapezoidal. However, as also depicted in FIGS. 5B and 5C, because underlying layer 306 was initially exposed at a point, metal layer 102 remains continuous during the electropolishing process. As depicted in FIG. 5D, because metal layer 102 remains continuous, metal layer 102 can be electropolished at a relatively high rate and without residuals remaining on underlying layer 306 after the electropolishing process.

With reference again to FIG. 2, in one exemplary embodiment, the polishing profile can be adjusted by adjusting the polishing charge, in particular the polishing current, applied to stream of electrolyte 108. For example, when stream of electrolyte 108 is applied to the portion of the metal layer adjacent to the center portion of wafer 100 (corresponding to the first stage described above), a first polishing current is applied to stream of electrolyte 108 to produce a triangular polishing profile. When stream of electrolyte 108 is applied to portions of the metal layer away from the center portion of wafer 100 and toward the edge portion of wafer 100 (corresponding to the second stage described above), a second polishing current, which is higher than the first polishing current, is applied to stream of electrolyte 108 to produce a trapezoidal polishing profile.

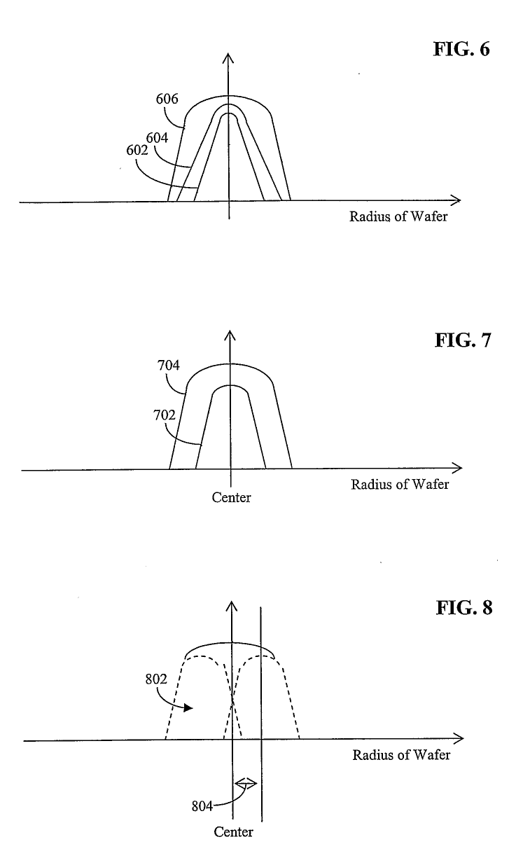

FIG. 6 depicts polishing profiles 602, 604, and 606 resulting from low, medium, and high polishing currents, respectively. As depicted in FIG. 6, the low polishing current produces polishing profile 602 that is more triangular and has a sharper apex than polishing profiles 604 and 606. In the present exemplary embodiment, the polishing current can range between about 0.05 Amperes and about 3 Amperes.

With reference again to FIG. 2, in one exemplary embodiment, the polishing profile can be adjusted by adjusting the size of nozzle 106. In particular, when stream of electrolyte 108 is applied to the portion of the metal layer adjacent to the center portion of wafer 100 (corresponding to the first stage described above), stream of electrolyte 108 is applied using a first nozzle to produce a triangular polishing profile. When stream of electrolyte 108 is applied to portions of the metal layer away from the center portion of wafer 100 and toward the edge portion of wafer 100 (corresponding to the second stage described above), stream of electrolyte 108 is applied using a second nozzle, which is larger than the first nozzle but with the same polishing current density, to produce a trapezoidal polishing profile.

FIG. 7 depicts polishing profiles 702 and 704 resulting from using small and large nozzles, respectively, which use the same polishing current density. As depicted in FIG. 7, the small nozzle produces polishing profile 702 that is more triangular and has a sharper apex than polishing profile 704. In the present exemplary embodiment, the polishing current density can range between about 0.05 Amperes/cm² and about 5 Amperes/cm².

With reference again to FIG. 2, in another exemplary electropolishing process, rather than aligning nozzle 106 and wafer 100 to position nozzle 106 adjacent to the center portion of wafer 100, nozzle 106 and wafer 100 are aligned to position nozzle 106 off-center to the center portion of wafer 100 by an off-set distance to initially electropolish the center portion of wafer 100. The off-set distance is equal to or less than the radius of the contact area of stream of electrolyte 108 on metal layer 102 so that the contact areas of stream of electrolyte 108 overlap as wafer 100 is rotated. FIG. 8 depicts a polishing profile 802, which is depicted as being trapezoidal, produced from an off-set distance of 804.

With reference to FIG. 2, in one exemplary embodiment, as stream of electrolyte 108 is applied from the center portion of wafer 100 toward the edge portion of wafer 100, the lateral relative speed between wafer 100 and nozzle 106 can be controlled according to the following formula:

$$\begin{matrix}V ( x ) = C / ( {π ( x + r )}^{2} ) , when x < r \\ = C / ( {π ( x + r )}^{2} - {( x - r )}^{2} ) , when x > r\end{matrix} \qquad ( 1 )$$

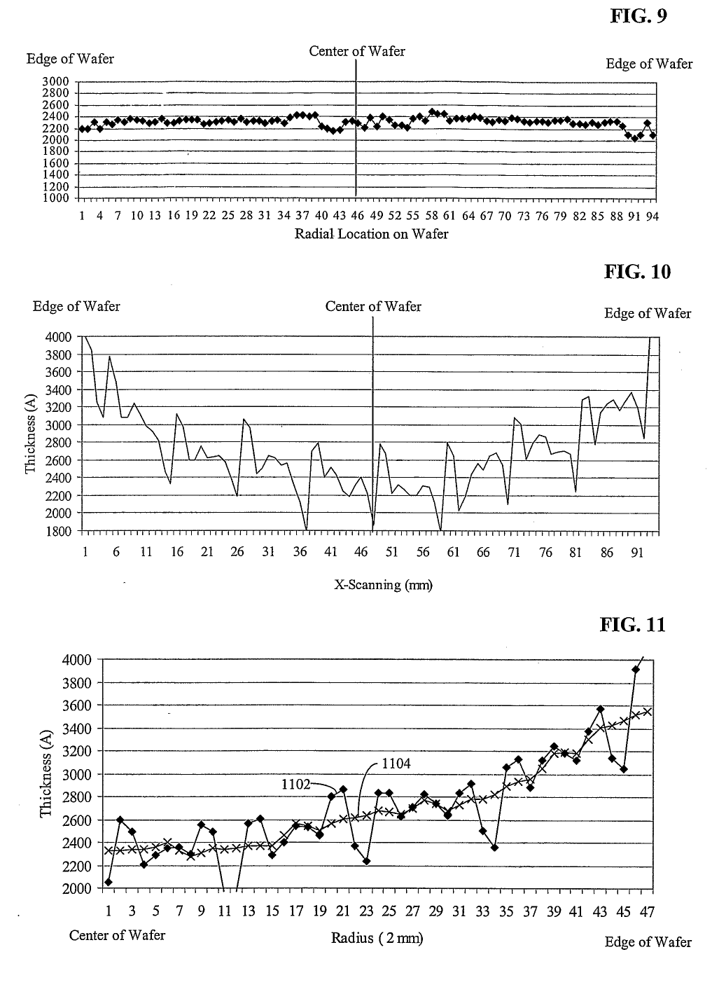

V(x) is the lateral relative speed or velocity. C is a constant. x is a radial location from the center of wafer 100 in the x-direction in the coordinate system depicted in FIG. 2. r is the radius of stream of electrolyte 108. See also, U.S. Pat. No. 6,395,152, issued May 28, 2002, which is incorporated herein by reference in its entirety. FIG. 9 depicts a thickness profile across the wafer resulting from applying formula (1).

However, as described above, with reference to FIG. 3A, before metal layer 102 is polished, thickness 302 of metal layer 102 is typically not uniform across wafer 100. In particular, FIG. 3A depicts initial thickness 302 of metal layer 102 being greater toward the edge portion of wafer 100 than toward the center portion of wafer 100.

For example, FIG. 10 depicts the thickness profile of a patterned wafer across the wafer. As depicted in FIG. 10, the thickness of the metal layer is relatively greater near the edge portion of the wafer compared to near the center portion of the wafer. As also depicted in FIG. 10, the thickness of the metal layer fluctuates across the wafer due to patterning effect under the metal layer.

Thus, in one exemplary embodiment, the polishing profile is tuned to match the thickness profile of a wafer. In particular, with reference to FIG. 2, before electropolishing metal layer 102, the thickness profile of metal layer 102 on wafer 100 is obtained. As stream of electrolyte 108 is applied onto metal layer 102 between the center portion and the edge portion of wafer 100 to electropolish metal layer 102, the lateral relative speed between wafer 100 and nozzle 106 is varied based on the obtained thickness profile of metal layer 102. While stream of electrolyte is applied onto metal layer 102 between the center portion and the edge portion of wafer 100, the rate of rotation of wafer 100 can be kept constant or varied.

In addition to fluctuations in the thickness of metal layer 102 across wafer 100 at different radial locations, the thickness of metal layer 102 can vary at different circumferential locations (theta locations) at a particular radial location on wafer 100 due to pattern sensitivity. For example, the thickness of metal layer 102 at a particular point on wafer 100 located at a radial location and at a theta location can differ from another point on wafer 100 located at the same radial location but at a different theta location, in part, because the two points have different wire patterns underneath metal layer 102.

Thus, in one exemplary embodiment, a first set of averaged thicknesses at different radial locations on wafer 100 is calculated of thicknesses at two or more points at the same radial location but different theta locations on wafer 100. A second set of averaged thicknesses at different radial locations on wafer 100 are then calculated using two or more of the averaged thicknesses from the first set of averaged thicknesses. The second set of averaged thicknesses is then used as the thickness profile of metal layer 102 in varying the lateral relative speed between wafer 100 and nozzle 106.

For example, with reference to FIG. 11, points on curve 1102 are averages of thicknesses at two points at the same radial locations but different theta locations on wafer 100, which are depicted in FIG. 10. Points on curve 1104 are averages of eight surrounding points on curve 1102. It should be recognized, however, that any number of surrounding points can be averaged, such as 2 to 20 points.

In one exemplary embodiment, a lateral relative speed compensation factor at a radial location on the wafer is determined based on the second set of averaged thicknesses at the different radial location on the wafer. The lateral relative speed between the wafer and the nozzle at a radial location can be determined by the lateral relative speed compensation factor at the radial location. Lateral relative speed compensation factors across the wafer can then be compiled as a lateral relative speed compensation factor curve for the wafer.

For example, a lateral relative speed compensation factor can be calculated using the following formula:
X(x)=(Ts(x)/Ta(x))^{α} (2)
X(x) is the lateral relative speed compensation factor. x is the radial location from the center portion on the wafer. Ts(x) is a thickness of the metal layer at a radial location resulting from electropolishing the metal layer without varying the lateral relative speed, such as the thicknesses depicted in FIG. 9. Ta(x) is the averaged thickness at a radial location, such as the averaged thicknesses depicted in FIG. 11. α is an acceleration factor, which can vary between 1 to 2 depending on the difference between Ts(x) and Ta(x). In particular, in the present exemplary embodiment, the greater the different between Ts(x) and Ta(x), the greater the acceleration factor. The lateral relative speed of the wafer and the nozzle is determined by multiplying the compensation factor determined by formula (2) with formula (1).

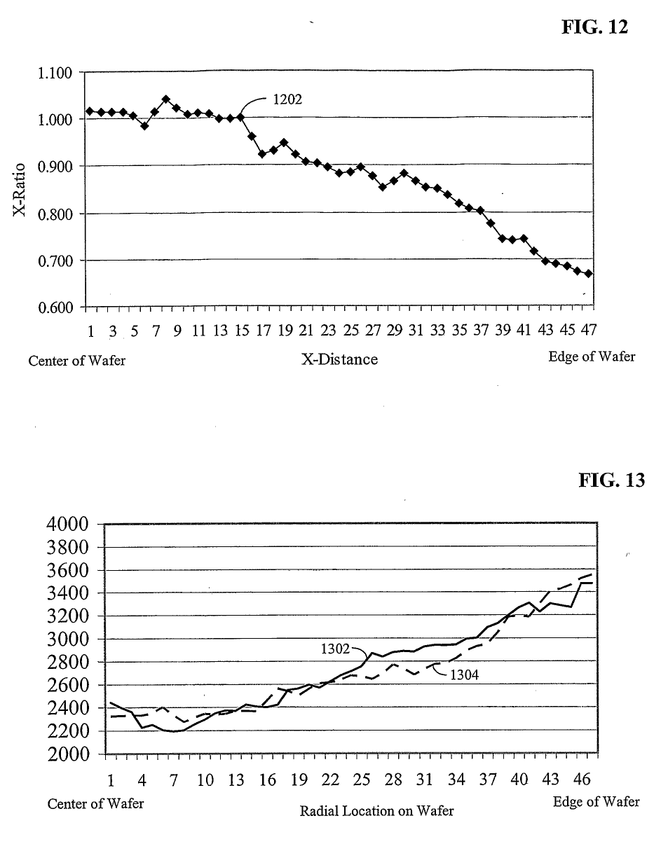

FIG. 12 depicts an exemplary lateral relative speed compensation curve 1202 generated based on the thicknesses of the metal layer at radial locations resulting from electropolishing the metal layer without varying the lateral relative speed, such as the thicknesses depicted in FIG. 9, and the averaged thicknesses depicted in FIG. 11. FIG. 13 depicts a curve 1302 of thicknesses across the wafer after electropolishing the metal layer using the lateral relative speed compensation factor defined by formula (2) with an acceleration factor of 1.2. FIG. 13 also depicts a curve 1304 of thicknesses across the wafer of average thickness of a metal layer on an incoming wafer before electropolishing.

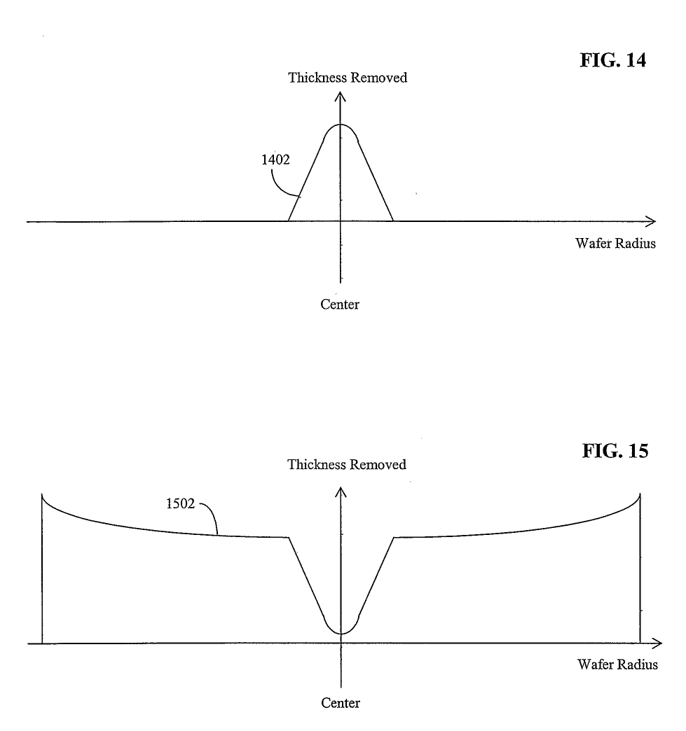

FIG. 14 depicts a triangular polishing profile 1402 resulting from a two-stage metal removal process described above. In particular, a polishing current of 0.2 Amperes can be applied to the stream of electrolyte applied from the nozzle onto the portion of the metal layer adjacent to the center portion of the wafer to produce triangular polishing profile 1402. FIG. 15 depicts a polishing profile 1502 resulting from adjusting the lateral relative speed of the wafer and the nozzle based on the incoming thickness profile of the metal layer on the wafer. In one exemplary embodiment, in order to increase the uniformity of the removal rate adjacent to the center portion of the wafer, polishing profile 1502 is reduced adjacent to the center portion of the wafer by either reducing the polishing current to as little as zero current and/or increasing the lateral relative speed compensation factor near the center portion of the wafer.

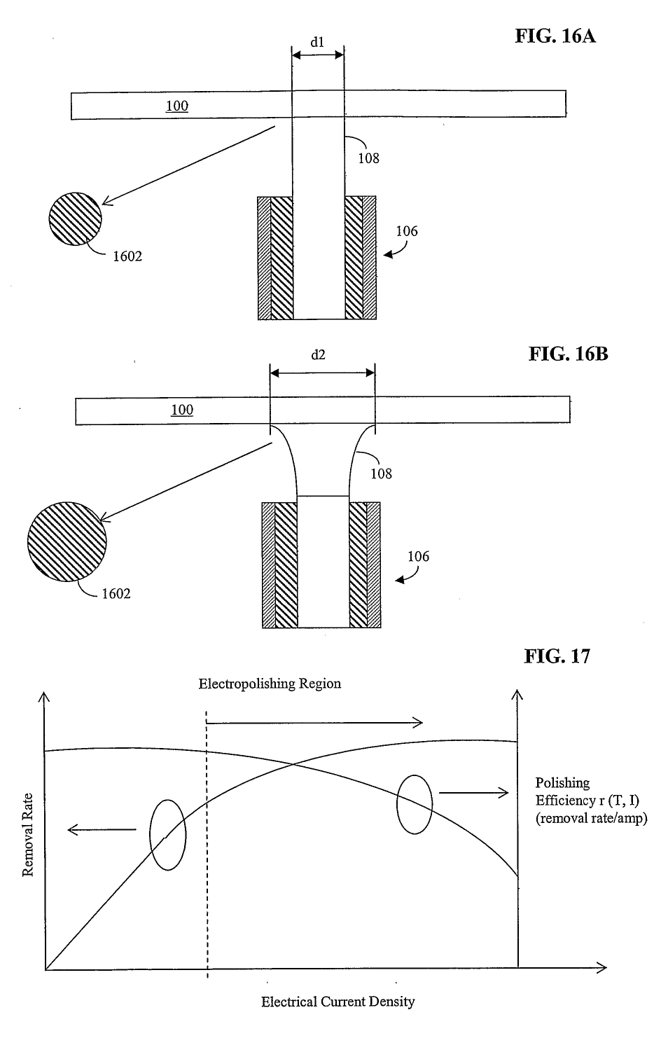

With reference to FIG. 16A, as described above, stream of electrolyte 108 is applied onto a metal layer formed on wafer 100 through nozzle 106 to electropolish the metal layer. As depicted in FIG. 16A, stream of electrolyte 108 is applied onto the metal layer at a contact area 1602 on the metal layer. When stream of electrolyte 108 is circular in shape, contact area 1602 has a circular shape with a diameter d1. As also depicted in FIG. 16A, when the flow rate is low and/or the viscosity of the electrolyte is high, diameter dl of contact area 1602 is about the same as the diameter of stream of electrolyte 108. As depicted in FIG. 16B, as a result of flow dynamics of the electrolyte, when the flow rate is increased and/or the viscosity of the electrolyte is decreased, the diameter of contact area 1602 increases to diameter d2.

FIG. 17 depicts a typical relationship between removal rate and polishing current density in an electropolishing process, such as the exemplary embodiment depicted in FIG. 2. As depicted in FIG. 17, as the current density increases to the electropolishing region, the slope of the removal rate begins to level out and the polishing efficiency (defined by removal rate/amp) is reduced.

With reference again to FIGS. 16A and 16B, assuming a constant polishing current, when contact area 1602 increases in size, the polishing current density decreases. According to the polishing efficiency curve depicted in FIG. 17, a lower current density corresponds to a higher polishing efficiency.

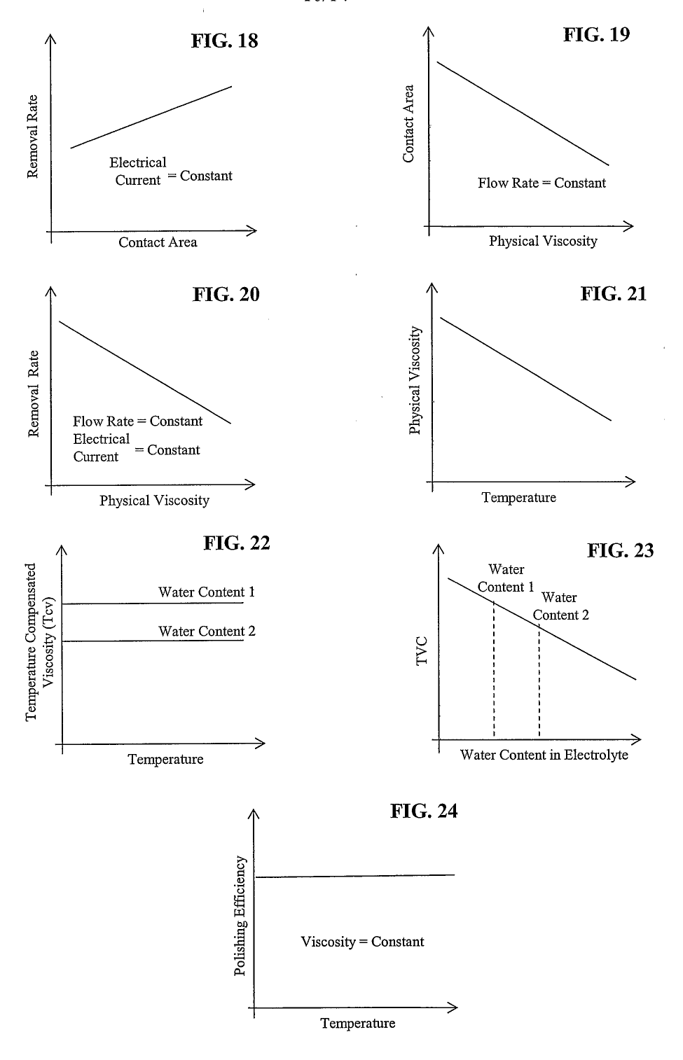

FIG. 18 depicts that when the polishing current is kept constant and the size of the contact area increases, the removal rate increases. Therefore, by keeping the size of the contact area constant, the removal rate can be maintained constant. The size of the contact area is affected by the viscosity of the electrolyte, flow rate, and the gap between the wafer and the nozzle.

FIG. 19 depicts that when the flow rate is kept constant and the physical viscosity of the electrolyte increases, the size of the contact area decreases. Thus, a higher viscosity produces a smaller contact area due to the dynamic nature of the electrolyte.

FIG. 20 depicts that when the flow rate is constant, the polishing current is constant, and the physical viscosity increases, the removal rate decreases. Thus, in order to maintain a constant removal rate, the physical viscosity of the electrolyte should be kept constant. It should be noted that a higher flow rate results in a larger contact area. Thus, the flow rate should also be kept constant in order to maintain a constant removal rate.

The viscosity of electrolyte is determined by two primary parameters: (1) temperature of the electrolyte; and (2) the composition of the electrolyte. FIG. 21 depicts that as temperature increases, the physical viscosity of the electrolyte decreases. Thus, the viscosity of the electrolyte can be kept constant by adjusting the temperature of the electrolyte.

In a typical electropolishing electrolyte, which is acid base, salt base, or alkali base, water is easily removed from, or added into, the electrolyte by evaporation or absorption. An increase in the water content in the electrolyte will generally result in a reduction of the viscosity of the electrolyte.

Thus, in one exemplary embodiment, to maintain a constant polishing rate, a constant viscosity of the electrolyte in the stream of electrolyte is maintained as the stream of electrolyte is applied onto the metal layer between the center portion and the edge of the wafer. In the present exemplary embodiment, the viscosity of the electrolyte is maintained constant by measuring the water content in the electrolyte and controlling a water-to-electrolyte balance in the electrolyte based on the measured water content in the electrolyte.

The water content in the electrolyte can be measured using a temperature compensated viscosity (Tcv) meter. As depicted in FIG. 22, Tcv factors out the temperature effect on viscosity. Thus, as depicted in FIG. 23, because a change in the water content in the electrolyte is reflected in a change in Tcv, Tcv can be used to indirectly measure the water content in the electrolyte.

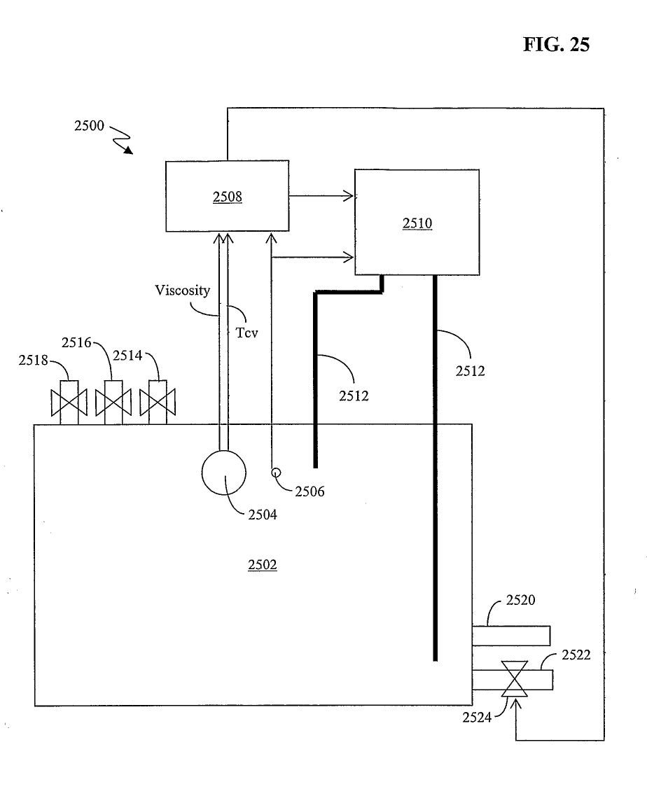

With reference to FIG. 25, an exemplary system 2500 to control the viscosity and water content in the electrolyte is depicted. In one exemplary embodiment, system 2500 is a fully closed-loop automatic system. As depicted in FIG. 25, system 2500 includes an electrolyte reservoir 2502, a viscosity meter 2504, a temperature sensor 2506, a computer/processor 2508, a temperature control unit 2510, heating/coolant pipes 2512, electrolyte outlets 2514, 2516, 2518, an electrolyte return inlet 2520, a water dosing inlet 2522, and a water dosing control valve 2524.

In the present exemplary embodiment, electrolyte outlets 2514, 2516, 2518 supply electrolyte to one or more nozzles 106 (FIG. 2). After the electrolyte is applied as stream of electrolyte 108 (FIG. 2), the electrolyte is returned to electrolyte reservoir 2502 through return inlet 2520.

In the present exemplary embodiment, the temperature within electrolyte reservoir 2502 is set at a certain level (a temperature set point) so that the water evaporation rate is slightly higher than the water absorption rate. The water content in the electrolyte can be maintained at a constant by dosing water into electrolyte reservoir 2502 through water dosing inlet 2522 using water dosing control valve 2524.

Note that the absorption rate and evaporation rate can depend on ambient moisture and temperature surrounding the electrolyte and/or electrolyte reservoir 2502. For example, for phosphoric-based electrolyte, the water evaporation rate is higher than water absorption rate if the temperature of electrolyte reservoir 2502 is set at 35° C. with ambient temperature of 20° C. and ambient moisture at 70%.

In the present exemplary embodiment, processor 2508 sends the temperature set point to temperature control unit 2510. Temperature control unit 2510 then adjusts its heating/coolant temperature based on the reading from temperature sensor 2506. The control mechanism used can be a typical proportion, integration, and deviation (PID) control process.

Viscosity meter 2504 sends a Tcv reading back to processor 2508. Processor 2508 sends signals to turn on water dose valve 2524 if the Tcv is lower than the temperature set point. The dose amount can be set based on pre-calibration data, such as the relationship between water content and Tcv depicted in FIG. 23, or on the particular PID process being used.

By using the closed water dose control mechanism described above, the water content can be measured and controlled at a certain value with minimum deviations. By controlling the water content, the physical viscosity of the electrolyte, and in turn the polishing rate, can be controlled.

In another exemplary embodiment, rather than measuring Tcv, viscosity meter 2504 can measure the physical viscosity of the electrolyte in electrolyte reservoir 2502. Viscosity meter 2504 sends the physical viscosity measurement to processor 2508. If the physical viscosity of the electrolyte is higher than a set point, processor 2508 sends a lower temperature set point to temperature control unit 2510. If the physical viscosity of the electrolyte is lower than a set point, processor 2508 sends a higher temperature set point to temperature control unit 2510. The appropriate temperature set point can be determined based on pre-calibrated data, such as the relationship between temperature and physical viscosity depicted in FIG. 21. Alternatively, a PID control process can be used, and the appropriate temperature set point can be determined based on the particular PID control process used.

Note that a constant physical viscosity can be maintained during a brief duration by adjusting temperature. A constant physical viscosity can be maintained for a longer duration by maintaining a constant water content in the electrolyte.

In one exemplary embodiment, a constant flow rate of the electrolyte is maintained in the stream of electrolyte as the stream of electrolyte is applied onto the metal layer between the center portion and the edge portion of the wafer. As described above, with reference to FIG. 2, the size of the contact area of stream of electrolyte 106 on wafer 100, and more particularly the metal layer being electropolished, is affected by the flow rate of the electrolyte. Thus, in the present exemplary embodiment, the polishing rate can be controlled by controlling the flow rate. In particular, the polishing rate can be kept constant by keeping the flow rate constant.

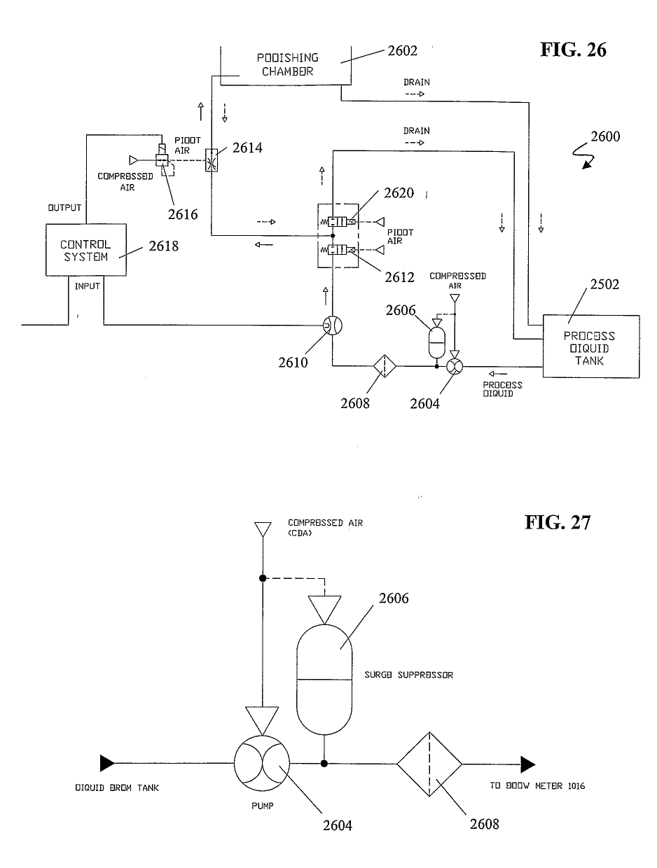

With reference to FIG. 26, an exemplary electrolyte supply system 2600 is depicted. In particular, electrolyte supply system 2600 supplies electrolyte from electrolyte reservoir (process liquid tank) 2502 to one or more nozzles 106 (FIG. 2) in polishing chamber 2602.

In the present exemplary embodiment, a pump 2604, which is operated by compressed air, pumps electrolyte from electrolyte reservoir 2502. As depicted in FIGS. 26 and 27, the same compressed air line that operates pump 2604 also operates a surge suppressor 2606, which acts as a buffer to reduce the pressure pulses of electrolyte being pumped through the supply line. As also depicted in FIGS. 26 and 27, a filter 2608 can filter the electrolyte in the supply lines.

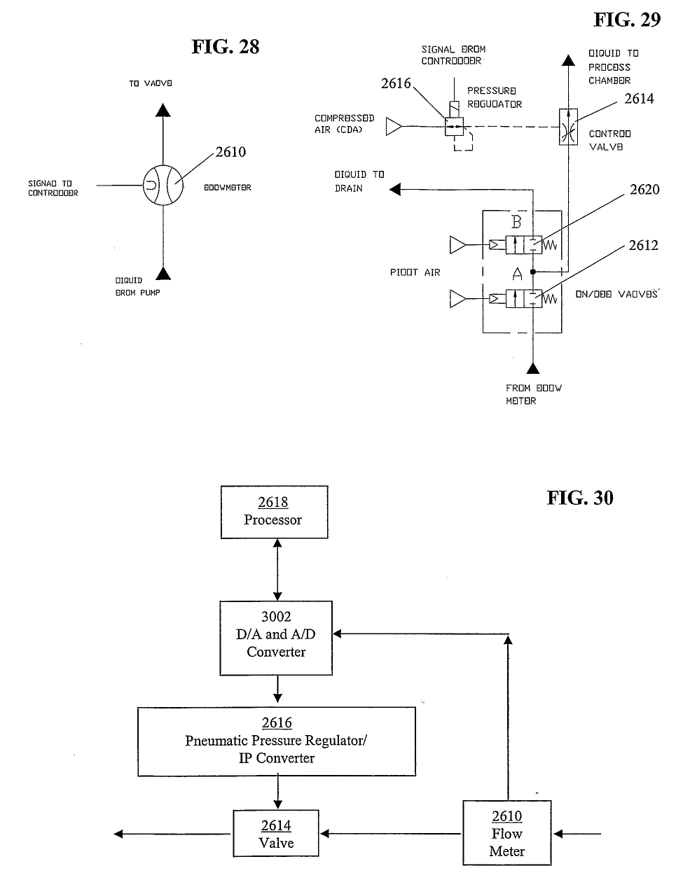

With reference to FIGS. 26 and 28, a flow meter 2610 can measure the flow rate of electrolyte in the supply line. As depicted in FIGS. 26 and 28, flow rate meter 2610 sends the flow rate data to a control system/processor 2618. It should be recognized that processor 2618 can be the same as processor 2508 (FIG. 25).

With reference to FIGS. 26 and 29, a first pneumatic ON/OFF valve 2612 opens or closes to start or stop the flow of electrolyte to one or more nozzles 106 (FIG. 2) in polishing chamber 2602. A second pneumatic ON/OFF valve 2620 is used to drain electrolyte from the supply line and polishing chamber 2602 into electrolyte reservoir 2502. As depicted in FIGS. 26 and 29, first pneumatic ON/OFF valve 2612 and second pneumatic ON/OFF valve 2620 are operated by pilot air.

With continued reference to FIGS. 26 and 29, a control valve 2614 controls the flow rate of the electrolyte being supplied to the one or more nozzles (FIG. 2) in polishing chamber 2602. As depicted in FIGS. 26 and 29, control valve 2614 is operated by pilot air from a pneumatic pressure regulator 2616, which receives signals and is controlled by processor 2618.

With reference to FIG. 26, in the present exemplary embodiment, processor 2618 uses the flow rate measured by flow meter 2610 to send control signals to control valve 2614 to control and regulate the flow rate of electrolyte in the supply lines. In particular, processor 2618 sends control signals to pneumatic pressure regulator 2616, which can increase or decrease the pressure of pilot air to control valve 2614 to cause it to pass more or less electrolyte to achieve the desired flow rate. In the present exemplary embodiment, if pneumatic pressure regulator 2616 does not receive a control signal from control system 2618, it sets the pilot air to zero and control valve 2614 is closed.

When electrolyte is to be supplied to polishing chamber 2602, second pneumatic ON/OFF valve 2620 is closed, while both first pneumatic ON/OFF valve 2612 and control valve 2614 are opened. When electrolyte is to be supplied back to electrolyte reservoir 2502 while bypassing polishing chamber 2602, control valve 2614 is closed, while both first pneumatic ON/OFF valve 2612 and second pneumatic valve 2620 are opened. Note that when control valve 2614 is closed and first and second pneumatic ON/OFF valves 2612, 2620 are opened, electrolyte in the supply line between control valve 2614 and first pneumatic ON/OFF valve 2612 can drain back to electrolyte reservoir 2502.

FIG. 30 depicts portions of the electrolyte supply system described above simplified as a block diagram. In particular, FIG. 30 depicts processor 2618 connected to pneumatic pressure regulator or current to pressure (IP) converter 2616 through a digital/analog (D/A) and analog/digital (A/D) converter 3002, which receives flow rate measurements from flow meter 2610. Pneumatic pressure regulator or IP converter 2616 is connected to control valve 2614, which is also connected to flow meter 2610.

In one exemplary embodiment, a look-up table is used to determine the appropriate pressure of pilot air to control valve 2614 to cause it to pass the appropriate amount of electrolyte to achieve the desired flow rate. The following describes a process by which processor 2618 generates the look-up table:
1. Processor 2618 sends command to pneumatic pressure regulator or IP converter 2616 to generate one Nth of full pressure P0. N is an integer, which preferably is in a range between 5 and 100, and more preferably is 30.
2. Processor 2618 records the flow rate measured by flow meter 2610 through A/D converter 3002.
3. Processor 2618 sends command to pneumatic pressure regulator or IP converter 2616 to generate two Nth of full pressure.
4. Processor 2618 records the flow rate measured by flow meter 2610 through A/D converter 3002.
5. Repeats steps 3 and 4 for additional points 3, 4, . . . , N-1, N separately.

The resulting look-up table is depicted below:

| | | | | | |
|---|---|---|---|---|---|
| Point 1 | . . . | Point(n − 1) | Point(n) | . . . | Point N |
| P0*1/N | . . . | P0*(n − 1)/N | P0*n/N | . . . | P0 |
| f(1) | . . . | f(n − 1) | f(n) | . . . | f(N) |

Once the look-up table has been generated, for a desired flow rate (f0), processor 2618 can search the look-up table for an entry with a matching flow rate to determine the appropriate pressure set point to provide to pneumatic pressure regulator or IP converter 2616.

If the desired flow rate (f0) is not in the look-up table, processor 2618 interpolates between at least two points in the look-up table. In particular, processor 2618 finds a range f(n−1) and f(n) such that f(n−1)<f0<f(n). Processor 2618 then calculates an initial pressure set point P1 as follows:
P1−P0*(n−1)/N+(f0−f(n−1))*((P0*n/N)−P0*(n−1)/N))/(f(n)−f(n−1)) (3)
The initial pressure set point P1 is sent to pneumatic pressure regulator or IP converter 2616, which then supplies pressure P1 to control valve 2614 to produce an initial flow rate (f1).

If f1 is sufficiently different from f0, such as beyond an established margin of error, the following formula can be used to adjust the flow rate again:
P2=P1+(f0+f1)*((P0*n/N)−P0*(n−1)/N))/(f(n)−f(n−1)) (4)
Additional flow measurements are then repeated obtained from flow meter 2610 to adjust the pressure being supplied to control valve 2614 to maintain a flow rate closest to the desired set point.

Note that the look-up table can be regenerated or updated periodically depending on the stability of control valve 2614, A/D and D/A converter 3002, and pneumatic pressure regulator or IP converter 2616. Note also that the process described above is useful when upstream or downstream pressure varies during the polishing operation.

FIG. 24 depicts a relationship between polishing efficiency and temperature at a constant contact area. As temperature increases, the polishing efficiency increases due to the chemical effect of electrolyte. As described above, the temperature of the electrolyte can be used as a variable to adjust the physical viscosity of the electrolyte to maintain a constant contact area.

Thus, in one exemplary embodiment, the temperature of the electrolyte is measured. The polishing current applied to the stream of electrolyte is then adjusted based on the temperature of the electrolyte. For example, when the temperature of the electrolyte increases, the polishing current can be reduced to compensate. In particular, the polishing current can be set as follows:

$$I = {I}_{0} - \frac{{I}_{0} ( \frac{d ρ ( {T}_{0} , {I}_{0} )}{dT} ) dT}{ρ ( {T}_{0} , {I}_{0} ) + \frac{d ρ ( {T}_{0} , {I}_{0} )}{dI} {I}_{0}} \qquad ( 5 )$$

I₀ is the set point of the polishing charge. T₀ is the temperature set point. dT is the temperature deviation from the temperature set point T₀. ρ(T, I) is the polishing efficiency function.

With reference to FIG. 25, during the electropolishing process, gas bubbles (oxygen and hydrogen) are generated. The gas bubbles mix with the electrolyte and flow back to electrolyte reservoir 2502. The gas bubbles can move to the surface of the electrolyte in electrolyte reservoir 2502 and into outlets 2514, 2516, and 2518. If the gas bubbles are pumped back to a nozzle, the gas bubbles can reduce the effective contact area, which can reduce removal rate.

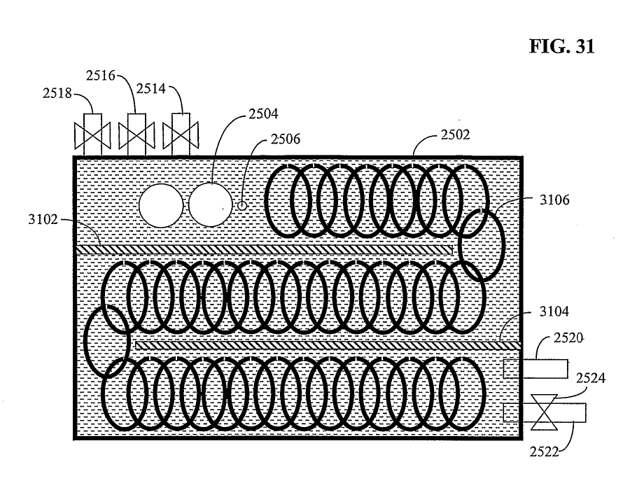

Thus, in one exemplary embodiment, gas bubbles are removed from the electrolyte in electrolyte reservoir 2502 before pumping the electrolyte back to the nozzle from electrolyte reservoir 2502. In particular, with reference to FIG. 31, to remove gas bubbles from the electrolyte in electrolyte reservoir 2502, dividers 3102 and 3104 are placed inside electrolyte reservoir 2502. Dividers 3102 and 3104 are placed from the bottom of electrolyte reservoir 2502 to above the electrolyte surface.

As depicted in FIG. 31, dividers 3102 and 3104 divide electrolyte reservoir 2502 into three channels. The electrolyte entering through electrolyte return inlet 2520 travels through the three channels before being pumped back to the nozzles through outlets 2514, 2516, and 2518, which uniformly prolongs the return of the electrolyte.

In particular, the electrolyte flows back into electrolyte reservoir 2502 through return inlet 2520. The electrolyte flows from electrolyte return inlet 2520 through a first channel in a first direction. The electrolyte flows from the first channel into a second channel in a second direction, which is in the opposite direction from the first direction. The electrolyte flows from the second channel into a third channel in a third direction, which is the opposite direction from the second direction and in the same direction as the first direction. The electrolyte then flows from the third channel into outlets 2514, 2516, and 2518, which are located near the bottom of electrolyte reservoir 2502 to further reduce the likelihood of gas bubbles being pumped back to the nozzle. Heating/cooling elements 3106 can be disposed within the channels.

By prolonging the return of the electrolyte before pumping the electrolyte back to the nozzles, any gas bubbles in the electrolyte has enough time to rise to the surface of the electrolyte. See also, U.S. Provisional Patent Application Ser. No. 60/462,642, filed on Apr. 14, 2003, which is incorporated herein by reference in its entirety.

Although various exemplary embodiments have been described, it will be appreciated that various modifications and alterations may be made by those skilled in the art. For example, the various concepts described above can be used with an electropolishing device that uses an applicator that directly contacts the metal layer rather than a nozzle that directs a stream of electrolyte without directly contacting the metal layer.

1. A method of electropolishing a metal layer formed on a wafer, the wafer having a center portion and an edge portion, the method comprising:
aligning a nozzle and the wafer to position the nozzle adjacent to the center portion of the wafer;
rotating the wafer; and
as the wafer is rotated, applying a stream of electrolyte from the nozzle onto a portion of the metal layer adjacent to the center portion of the wafer to begin to electropolish the portion of the metal layer with a triangular polishing profile to initially expose an underlying layer underneath the metal layer at a point.

2. The method of claim 1, wherein the metal layer includes copper, and wherein the underlying layer is a barrier layer.

3. The method of claim 1, further comprising:
after the underlying layer has been initially exposed at a point, applying the stream of electrolyte from the nozzle onto additional portions of the metal layer extending from the center portion toward the edge portion of the wafer; and
adjusting the triangular polishing profile to have a flatter apex when the stream of electrolyte is applied to the additional portions of the metal layer.

4. The method of claim 3, wherein adjusting the triangular polishing profile comprises:
applying a first polishing current to the stream of electrolyte when the stream of electrolyte is applied to the portion of the metal layer adjacent to the center portion of the wafer; and
applying a second polishing current, which is higher than the first polishing current, when the stream of electrolyte is applied to the additional portions of the metal layer.

5. The method of claim 3, wherein adjusting the triangular polishing profile comprises:
applying the stream of electrolyte using a first nozzle when the stream of electrolyte is applied to the portion of the metal layer adjacent to the center portion of the wafer; and
applying the stream of electrolyte using a second nozzle, which is larger than the first nozzle, when the stream of electrolyte is applied to the additional portions of the metal layer.

6. The method of claim 1, wherein the wafer and the nozzle are not moved in a lateral direction when the stream of electrolyte is applied to the portion of the metal layer adjacent to the center portion of the wafer until the underlying layer is initially exposed at a point.

7. The method of claim 6, wherein, when the underlying layer is initially exposed at a point, the wafer or nozzle is moved in a lateral direction to apply the stream of electrolyte to additional portions of the metal layer extending from the center portion toward the edge portion of the wafer.

8. The method of claim 1, wherein aligning a nozzle adjacent to the center portion of the wafer comprises:
moving the wafer to align the center portion of the wafer adjacent to the nozzle.

9. The method of claim 1, wherein aligning a nozzle adjacent to the center portion of the wafer comprises:
moving the nozzle to align the center portion of the wafer adjacent to the center portion of the wafer.

10. The method of claim 1, wherein aligning a nozzle adjacent to the center portion of the wafer comprises:
moving the nozzle and the wafer relative to one another to align the nozzle adjacent to the center portion of the wafer.

11. A system to electropolish a metal layer formed on a wafer, the wafer having a center portion and an edge portion, the system comprising:
a wafer chuck to rotate the wafer; and
a nozzle,
wherein the nozzle and the wafer are aligned to position the nozzle adjacent to the center portion of the wafer, and
wherein, as the wafer is rotated, a stream of electrolyte is applied from the nozzle onto a portion of the metal layer adjacent to the center portion of the wafer to begin to electropolish the portion of the metal layer with a triangular polishing profile to initially expose an underlying layer underneath the metal layer at a point.

12. The system of claim 11, wherein the metal layer includes copper, and wherein the underlying layer is a barrier layer.

13. The system of claim 11,
wherein, after the underlying layer has been initially exposed at a point, the stream of electrolyte is applied from the nozzle onto additional portions of the metal layer extending from the center portion toward the edge portion of the wafer, and
wherein the triangular polishing profile is adjusted to have a flatter apex when the stream of electrolyte is applied to the additional portions of the metal layer.

14. The system of claim 13, further comprising a power supply configured to:
apply a first polishing current to the stream of electrolyte when the stream of electrolyte is applied to the portion of the metal layer adjacent to the center portion of the wafer; and
apply a second polishing current, which is higher than the first polishing current, when the stream of electrolyte is applied to the additional portions of the metal layer.

15. The system of claim 13, wherein the nozzle comprises:
a first nozzle configured to apply the stream of electrolyte when the stream of electrolyte is applied to the portion of the metal layer adjacent to the center portion of the wafer; and
a second nozzle configured to apply the stream of electrolyte when the stream of electrolyte is applied to the additional portions of the metal layer, wherein the second nozzle is bigger than the first nozzle.

16. The system of claim 11, wherein the wafer and nozzle are not moved in a lateral direction when the stream of electrolyte is applied to the portion of the metal layer adjacent to the center portion of the wafer until the underlying layer is initially exposed at a point.

17. The system of claim 16, wherein, when the underlying layer is initially exposed at a point, the wafer or nozzle is moved in a lateral direction to apply the stream of electrolyte to additional portions of the metal layer extending from the center portion toward the edge portion of the wafer.

18. The system of claim 11, further comprising a guide rod configured to move the wafer to align the center portion of the wafer adjacent to the nozzle.

19. The system of claim 11, further comprising a guide rod configured to move the nozzle to align the center portion of the wafer adjacent to the center portion of the wafer.

20. The system of claim 11, further comprising:
a first guide rod configured to move the nozzle; and
a second guide rod configured to move the wafer.

21-87. (canceled)
